(19) United States
(12) Patent Application Publication
(10) Pub. No.: US 2015/0252789 A1
(43) Pub. Date: Sep. 10, 2015

(54) Method for Detecting Deflection of the Blades of a Wind Turbine

(71) Applicant: Steffen Bunge, Pinawa (CA)

(72) Inventor: Steffen Bunge, Pinawa (CA)

(21) Appl. No.: 14/637,566

(22) Filed: Mar. 4, 2015

Related U.S. Application Data
(60) Provisional application No. 61/947,828, filed on Mar. 4, 2014.

(51) Int. Cl. F03D 11/00; F03D 1/06; G06T 7/00; F03D 11/04

(52) U.S. Cl. CPC F03D 11/0091; F03D 11/04; F03D 1/0675; G06T 7/0004; G06T 2207/10016; G06T 2207/30108

(57) ABSTRACT

An amount of the deflection of the blades of a rotor of a wind turbine of the type including a tower and a nacelle mounted to the top of the tower, the rotor being rotatably connected to the nacelle for rotating about a rotor axis and having a plurality of equally spaced blades includes positioning video cameras on the rotor at a root of a respective one of the blades so as to provide a line of sight of the camera along the respective one of the blades to the tip to obtain a video image of the rotor and tip and carrying out an analysis of the images of the tip to determine a position of the tip and hence the deflection of the tip time synchronized analyzed potentially with external data providing load, capacity, power produced or environmental data.

This application claims the benefit under 35 USC 119 (e) of Provisional Application 61/947828 filed Mar. 4, 2014.

This invention relates to a method for detecting deflection of the blades a rotor of a wind turbine of the type comprising a tower and a nacelle mounted to the top of the tower, the rotor being rotatably connected to the nacelle for rotating about a rotor axis and having a plurality of equally spaced blades around the axis.

### BACKGROUND OF THE INVENTION

Wind turbines in HAVVT design (horizontal axis) consist of four main parts as a structure, the base, the tower, the nacelle and the rotor with one or more blades.

The blades are mounted at fixed angularly spaced positions around the axis. The turbine includes a wind detection system which analyses the wind speed and direction repeatedly so as to repeatedly adjust the angle of the nacelle around a vertical axis of the tower, that is the angle of the rotor axis relative to the wind direction, and to adjust the angle of attack of the blades around the longitudinal axis of the blade relative to the wind speed.

A common target for structural measurements on wind turbine is to determine the deflection of rotor blades. This is either because the manufacturer wants to verify the original design or design improvements.

The setup of such a measurement is rather complicated and expensive (up to multiple $100,000) and time consuming. Typically this requires the application of strain gauges at predetermined positions along the length of the blade so that the deflection at leach location can be detected and analyzed.

Furthermore because of the expense of this method, testing is usually limited to one turbine without knowing if it is representative of multiple turbines. The conventional method is not suitable in a situation where the structural integrity of a blade is in question for example after lightning strikes.

### SUMMARY OF THE INVENTION

It is one object of the present invention to provide a method of detecting an amount of deflection of the blades of a rotor of a wind turbine which can be effectively and quickly used to detect deflection of the blade of a wind turbine for use in assessing structural integrity of the wind turbine. Using this method it may be possible to readily detect structural damage of the type causing unacceptable deflection before the damage to the blade can lead to catastrophic damage to the whole turbine.

According to the invention there is provided a method of detecting an amount of deflection of the blades of a rotor of a wind turbine,

the wind turbine comprising a tower and a nacelle mounted to the top of the tower, the rotor being rotatably connected to the nacelle for rotating about a rotor axis and having a plurality of equally spaced blades,

the method comprising:

positioning a video camera on the rotor at a root of a respective one of the blades so as to provide a line of sight of the camera along the respective one of the blades to the tip to obtain video images of the rotor and tip;

and carrying out an analysis of the images to determine a position of the tip and hence the deflection of the tip.

Preferably the method is for use in assessing structural integrity of the wind turbine. Using this method it may be possible to readily detect structural damage of the type causing unacceptable deflection before the damage to the blade can lead to catastrophic damage to the whole turbine.

Preferably the analysis is carried out by obtaining on the camera during rotation of the rotor a plurality of frames of the video image, selecting for analysis from the plurality of frames of the video image at least one frame for analysis and carrying out an analysis of the frame to determine a position of the tip of the blade in the frame. However the video image can be analyzed directly.

Preferably the frame selected is located at a predetermined angular position of the blade of the rotor. This can be done by including a known landmark component which is visible in the image or frame and typically this can be the horizon.

Preferably the predetermined angular position of the blade of the rotor is located at the horizon on the side angularly beyond the tower,

Preferably there is provided a camera on each blade and the method includes selecting and comparing the position of the tips in the frames. In this case the frames selected for the blades are preferably located at the same predetermined angular position of the blade of the rotor.

Preferably the video image is taken during a period of time which is sufficient in length to contain different loading conditions on the blades due to changes in wind conditions.

Preferably at least two frames are selected at different loading conditions for comparison of deflection at different loads and the method includes selecting and comparing the position of the tips in the frames at the same loading conditions and at the same angular orientation.

Preferably the image or frame is analyzed by detecting and defining in the frame the peripheral edge of blade.

Preferably the geometric dimensions of the blade at a known location on the blade are used in the image for calculating from those known dimensions a value for the deflection in actual length and verified against design values.

Preferably known width dimension at a predetermined visible position along the blade is used to calculate deflection.

Preferably the images are analyzed at different load, capacity, power produced or environmental data such as wind speed and similar.

The method as disclosed in detail herein may provide one or more of the following advantages and features:

The introduction of quick load assessments with hub/blade mounted cameras allows the system herein to verify and compare the mechanical deflection under a variety of load scenarios.

Mounting of multiple cameras can be done easily and quickly. There is virtually no time connected with production loss during installation or testing itself.

The cameras can be mounted usually while the designated wind speed is available.

To assess multiple turbines, the cameras can quickly be changed over to the next turbine. Alternatively in view of the relatively low cost of the equipment, a number of turbines can be assessed simultaneously. The conventional setup using strain gauges is usually installed during no/low wind situations and then stays at the turbine for several months.

At the end of a session using the present method, a huge number of blades can be compared to each other, rather than only three blades by a measurement done in the conventional way. If the results do show blades performing better or worse than the majority, then conventional testing can be performed on those turbines of particular interest.

The cameras can record up to 8 hours of video and depending on camera equipment and requirements, cameras can be equipped with external power supply and live off-camera storage to extend test periods to provide a number of different loading conditions within the recording session.

Most effective are positions at the horizon on the downwind side of the blade or hub bearing since it is expected that the blade will deflect in this direction. The camera is typically arranged looking along the blade, although other positions maybe required for different blade styles and blades with significant pre-bend up wind.

Typically four cameras can be used where three are mounted one on each blade and one is provided as a backup only. However a number of cameras can be arranged at positions all around the blade.

The cameras are preferably mounted with neodymium magnets on the outside of the main bearing, that is the blade bearing at the root of the blade. Where the steel hub or bearing is not accessible, the cameras can be mounted on a strap fixed around the blades root.

The cameras are preferably mounted on the high pressure side or downwind side of the blade looking along the blade at the leading edge. However the cameras can be mounted on the nacelle side looking at the “flat” low pressure side and at the trailing edge.

This procedure allows optically monitoring and documenting the deflection of the blades under load and comparison between the individual blades.

The camera can be aimed at a flat side of the blade to determine deflection but it may also be aimed at the contour lines at the trailing edge and leading edge.

The cameras are preferably located at the root of the blade depending on what area is accessible. This can be at the root of the blade for blades with a fiber glass body, with some sort of mounting apparatus, but it can be also mounted at any suitable surface like the blade bearing or hub body. The camera is to be mounted at the root circumference of the blade or at a similar position with the direction of view perpendicular to the blades longitudinal axis. The view can be along any side of the blade.

The camera is preferably lined up along the blade's longitudinal axes. Those are primarily the low and high pressure sides as well as the leading edge and trailing edge sides or anything in between and whatever can give the best results.

### BRIEF DESCRIPTION OF THE DRAWINGS

One embodiment of the invention will now be described in conjunction with the accompanying drawings in which:

FIG. 1 is a side elevational view of a conventional turbine showing the location of the cameras of the present invention.

FIG. 2 is view of the components of FIG. 1 looking along one blade showing optional placements of the cameras of the method of the present invention.

FIG. 3 is a front elevational view of the turbine of FIG. 1 showing optional placements of the cameras of the method of the present invention.

FIGS. 4A and 4B show side elevational views of a blade showing the cameras and the deflection of the blade.

FIGS. 5 and 6 show actual examples of two of the frames of the video image taken by the camera showing the edge of the blades for analysis of the deflection, the frames being selected at the horizontal at the downstream side of the tower and at different loading conditions.

FIGS. 7 and 8 show an analysis of the frames of FIGS. 5 and 6 to determine from the images the edge of the blades.

FIGS. 9 and 10 show an analysis of the frames of FIGS. 5 and 6 to show only the edges of the blades.

In the drawings like characters of reference indicate corresponding parts in the different figures.

### DETAILED DESCRIPTION

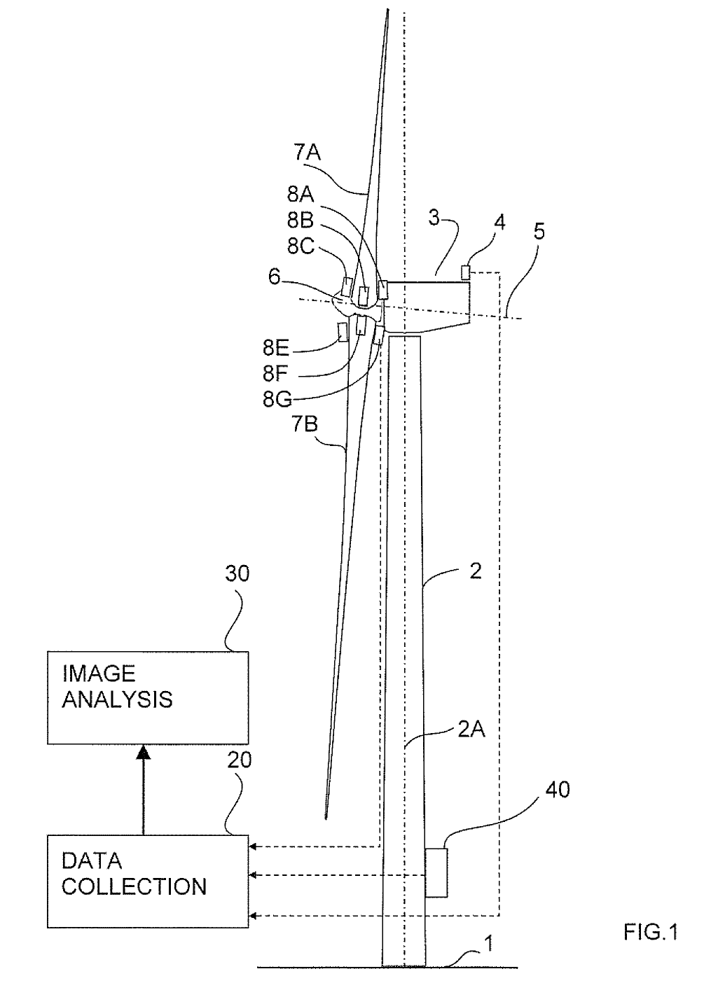

In FIG. 1 is shown a conventional wind turbine. This includes a nacelle 3 mounted on a tower 2 carried on a base 1. A main shaft (not shown) connects the drive train to the hub and rotor assembly of the hub body 6 carrying the blades 7. There are typically three blades 7A, 7B and 7C arranged at 120 degrees. The blades 7 are mounted at fixed angularly spaced positions around the rotor axis 5.

The turbine includes a wind detection and control system 4 in the form of an anemometer which analyses the wind speed and direction repeatedly so as to repeatedly adjust the angle of the nacelle 3 around a vertical axis 2A of the tower, that is the angle of the rotor axis relative to the wind direction, and to adjust the angle of attack of the blades 7 around the longitudinal axis of the blade relative to the wind speed.

The possible positions of the mounting of the video camera 8 on the blades 7A and 7B in relation to the hub 6 are shown in FIG. 1 as follows:

8A is located at the down-wind position of the first blade 7A;

Camera 8B is located at the leading edge position of the first blade 7A;

Camera 8C is located at the up-wind position of the first blade 7A;

Camera 8E is located at the up-wind position of the second blade 7B;

Camera 8F is located at the trailing edge position of the second blade 7B;

Camera is located at the down-wind position of the second blade 7B.

Also shown in FIG. 1 schematically are the components for carrying out the analysis including a data collection system 20 which collects data from the cameras 8, the wind detection and control system 4 and from the power output control 40. The turbines controller and SCADA (Data acquisition) system can be located off-site or on-site. This data can be synchronized in time by the data collection system to indicate in the images when certain conditions or load scenarios are encountered. The images and data associated therewith are then transmitted or supplied to an image analysis system 30 using the techniques described hereinafter.

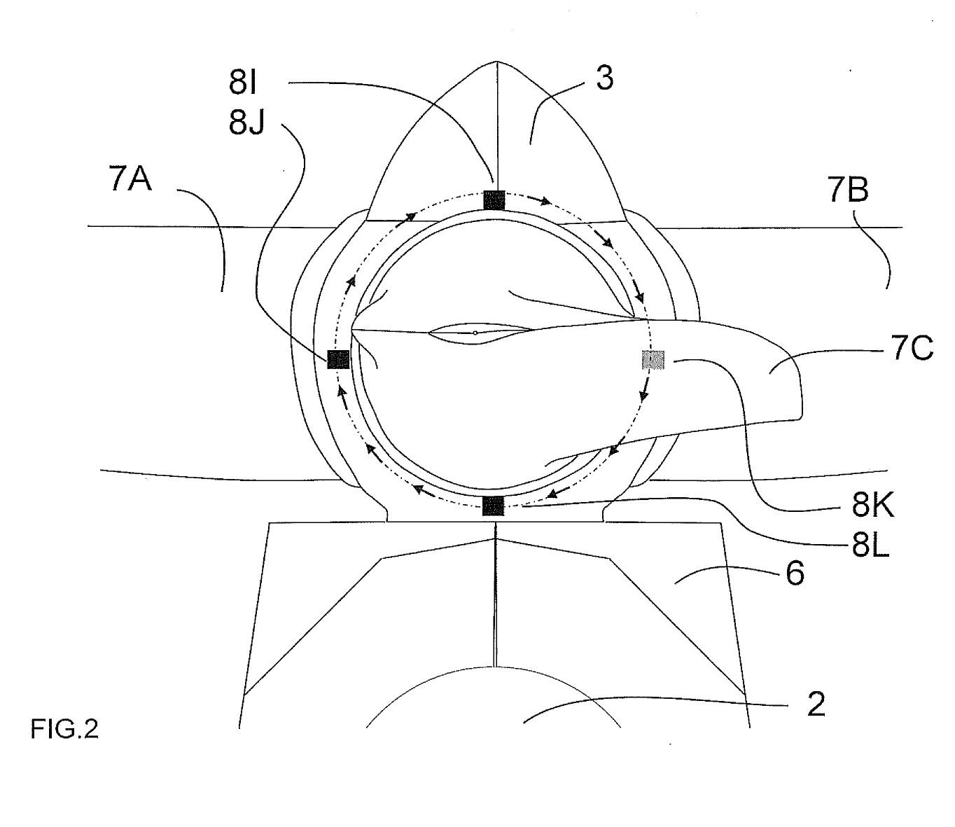

FIG. 2 is view of the components of FIG. 1 looking along one blade 7C and showing the other blades 7A and 7B in the common plane of the view carried on the hub body 6 mounted on the tower 2.

The possible positions of the mounting of the video camera 8 on the third blade 7C in relation to the nacelle 3 are shown in FIG. 2 as follows:

Camera 8I is located at the up-wind position;

Camera 8J is located at the leading edge position;

Camera 8K is located at the trailing edge position;

Camera 8L is located at the down-wind position.

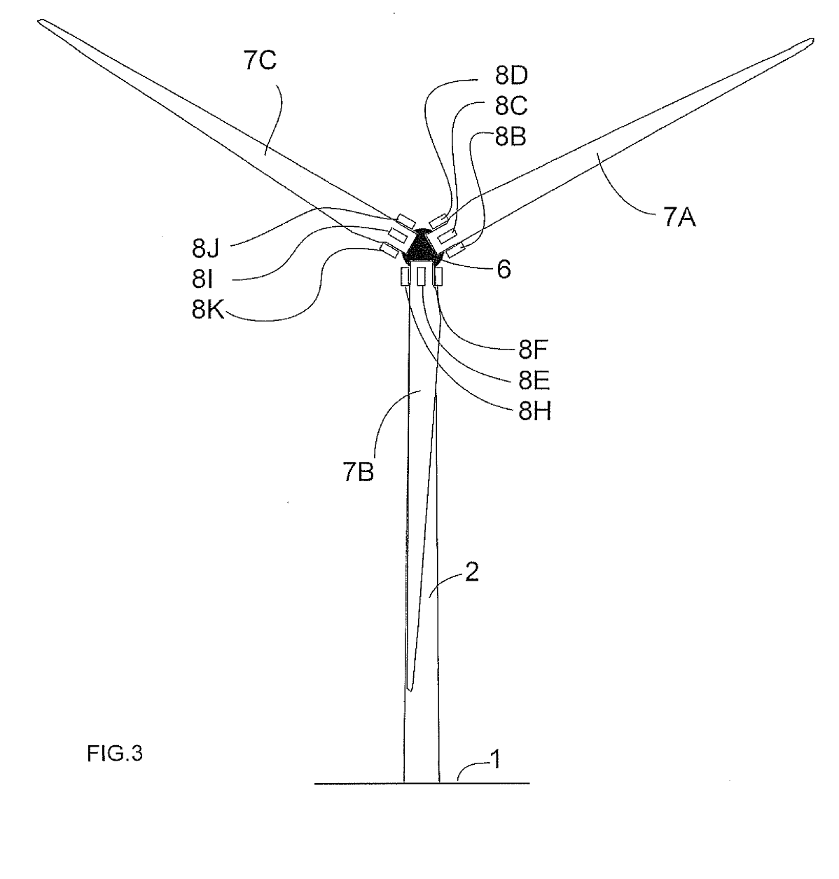

FIG. 3 is a front elevational view of the turbine of FIG. 1 showing the placement of the cameras of the method of the present invention, as follows:

Camera 8B is located at the leading edge position of the first blade 7A;

Camera 8C is located at the up-wind position of the first blade 7A;

Camera 8D is located at the trailing edge position of the first blade 7B;

Camera 8E is located at the up-wind position of the second blade 7B;

Camera 8F is located at the trailing edge position of the second blade 7B;

Camera 8H is located at the leading edge position of the second blade 7B;

Camera 8I is located at the up wind position of the third blade 7C;

Camera 8J is located at the leading edge position of the third blade 7C;

Camera 8K is located at the trailing edge position of the third blade 7C.

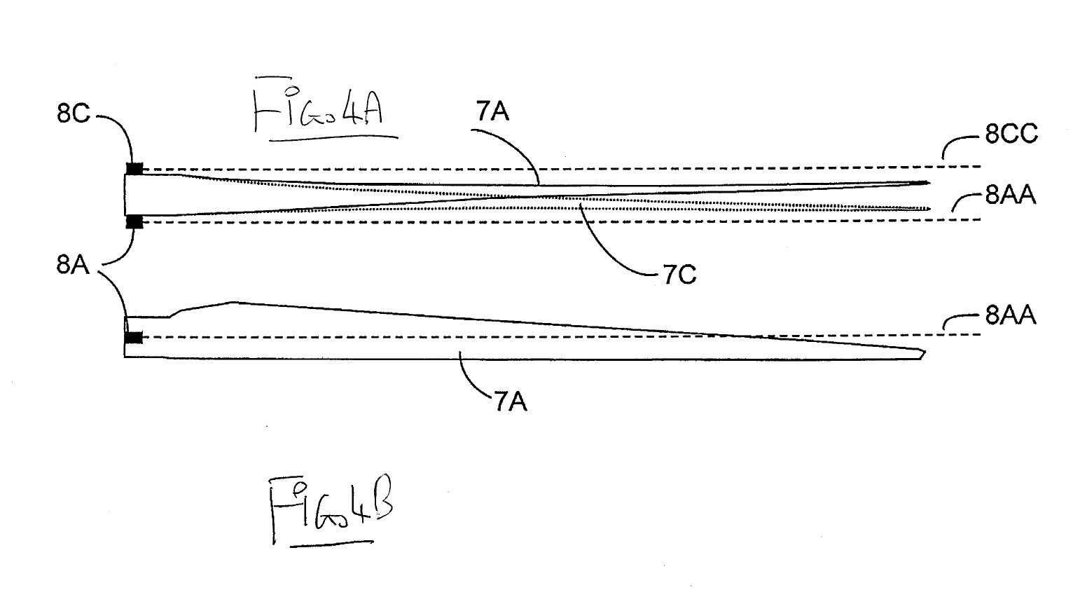

FIGS. 4A and 4B show the cameras 8A and 8C which are located as described above at the down-wind position and up-wind positions respectively together with the optical axis of each camera. 7A represents the blade in load free state, 7C represents the blade under load and deflection

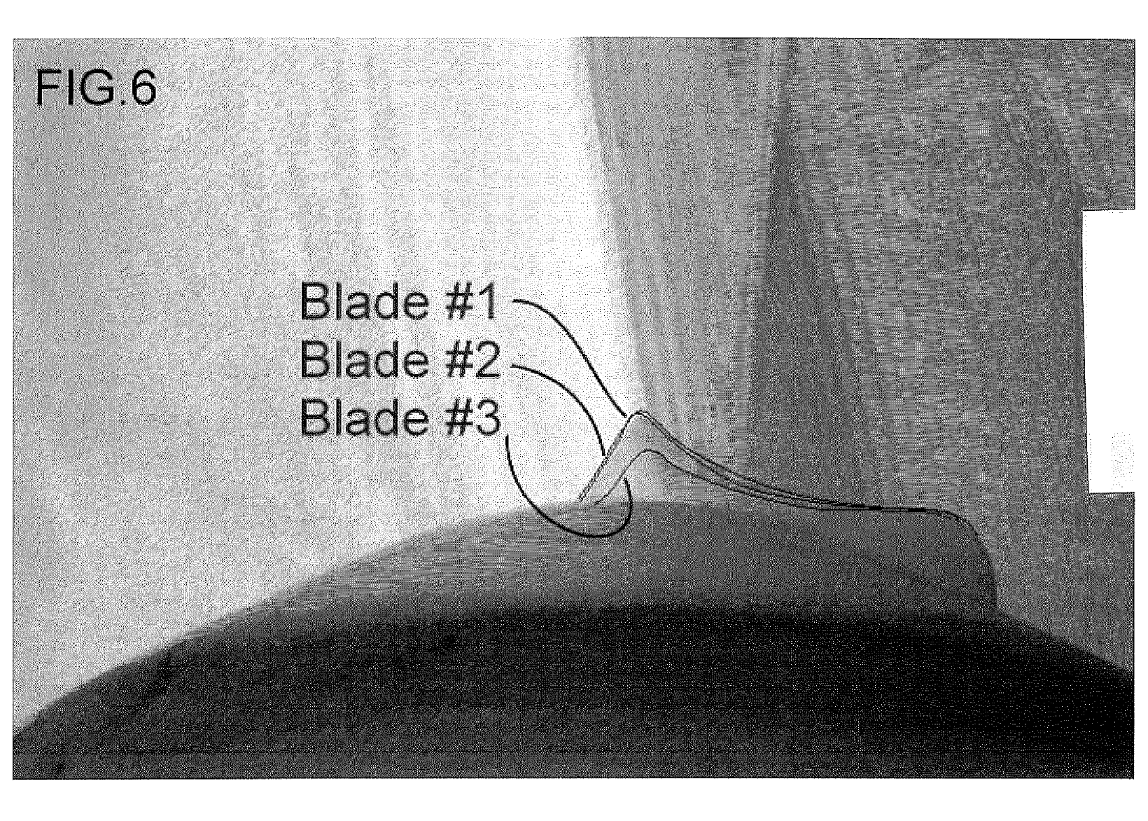

FIGS. 6, 7 and 9 show the turbine running at approximately 800 min-1 generator speed where the rotor speed is approximately 19.7 min-1, where all of the three blades #1, #2 and #3 all match closely. FIG. 6 shows the actual images taken from the video camera at the horizon on the downwind side where the three images have been selected and superimposed to show the three separate edges of the blades on the same image.

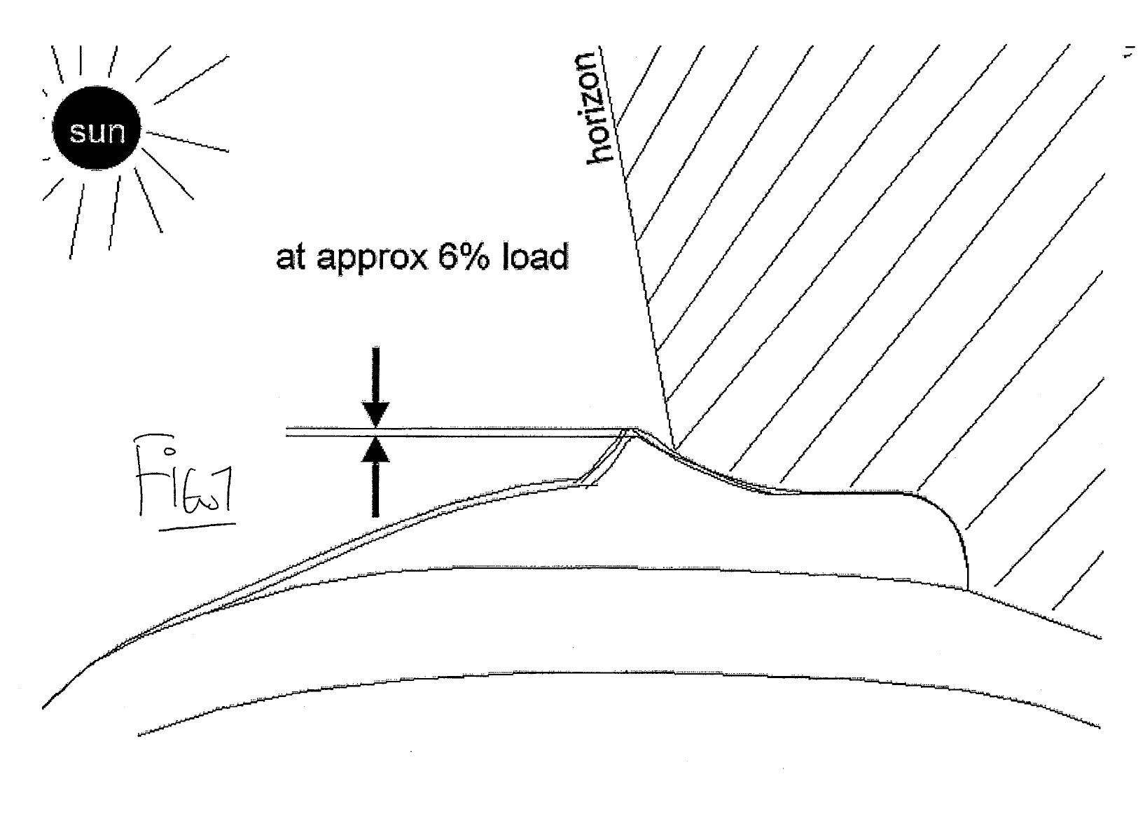

FIG. 7 shows the traced outline of the blade and the horizon as taken from the image of FIG. 6.

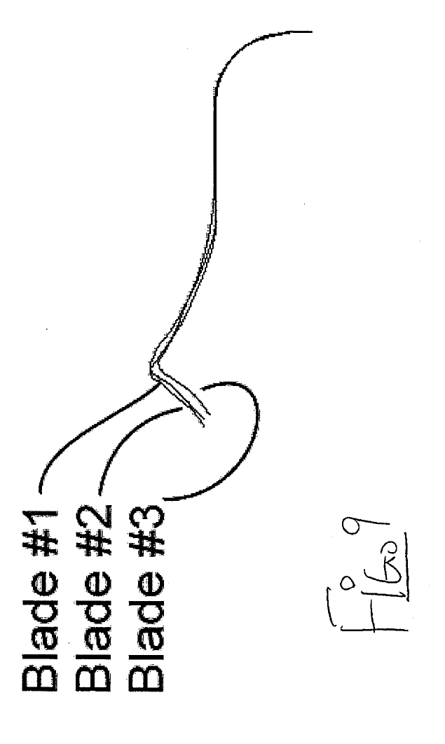

FIG. 9 shows the traced outline of the portion only of the blade which indicates the amount of the deflection.

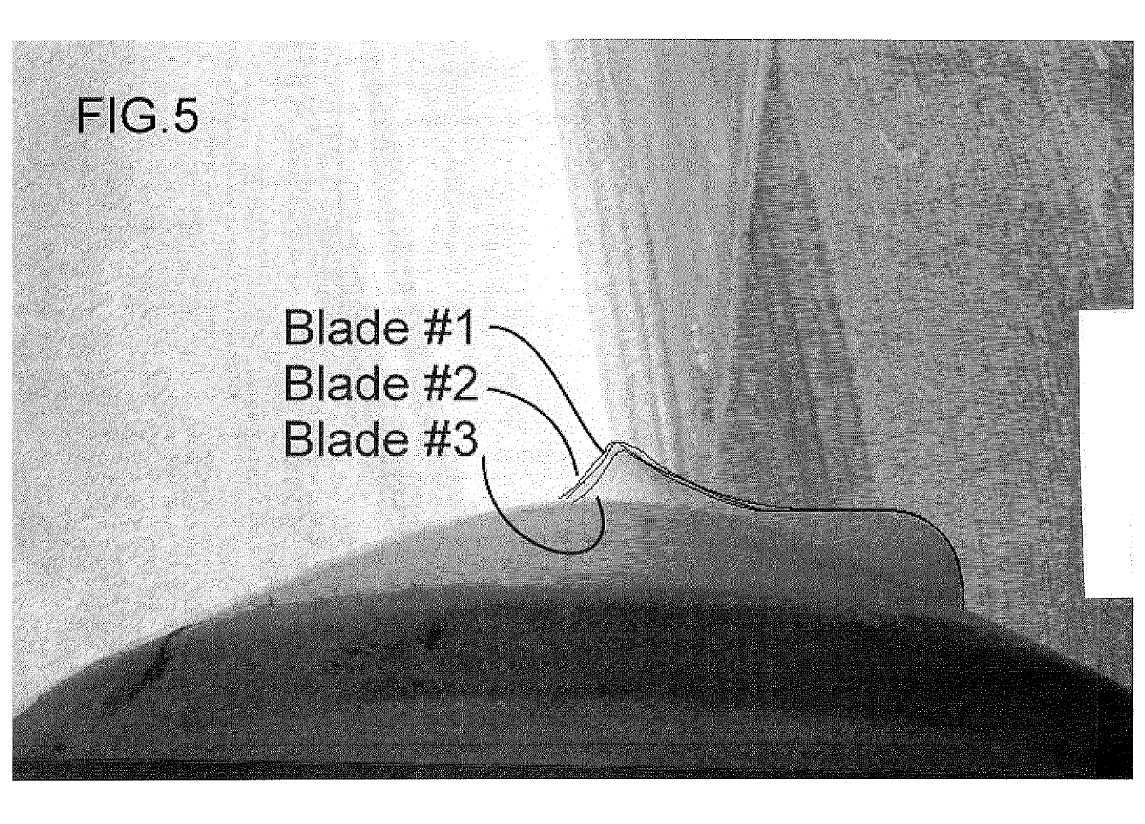

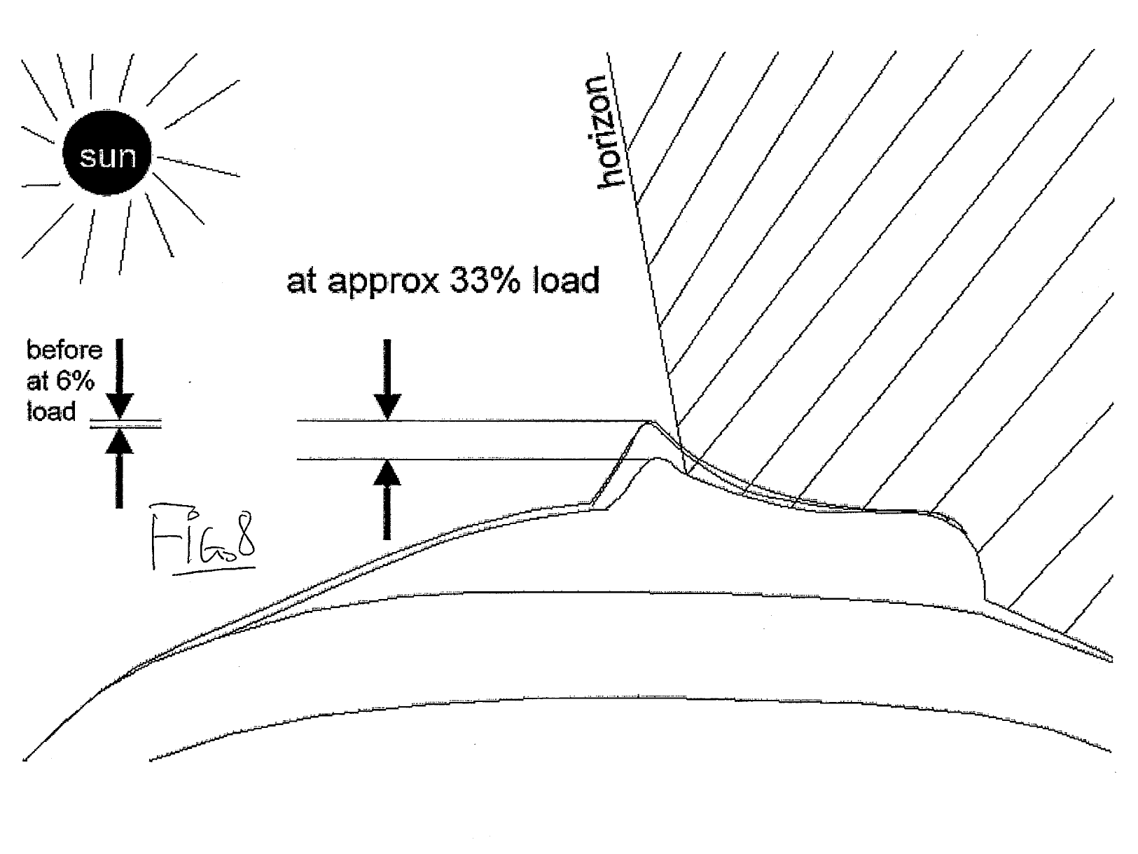

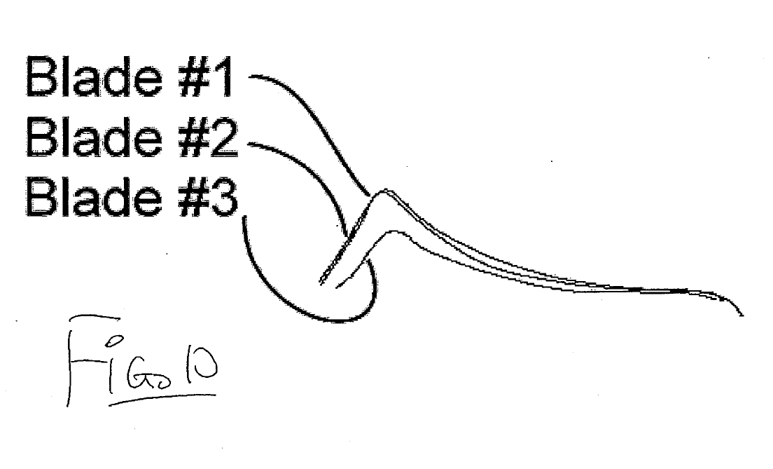

FIGS. 5, 8 and 10 show the turbine running at approximately 1000 min-1 generator speed where the rotor speed is approximately 24.6 min-1 where blade #3 (manufactured by a first manufacturer) appears to be stiffer not deflecting as much as the blades (manufactured by a second manufacturer). This analysis was carried out at a power rating of 350 kW relative to the maximum of 750 kW at full capacity. At 750 kW the differences will be even more distinguishable.

Thus the method of the present invention includes positioning a video camera 8 on the rotor at a root of a respective one of the blades so as to provide a line of sight of the camera along the respective one of the blades to the tip to obtain a video image of the rotor and tip. Still images taken from the video stream are shown in FIGS. 5 and 6. An analysis of the images of the tip as shown in FIGS. 7, 9, 8 and 10 to determine a position of the tip and hence the deflection of the tip.

The analysis is carried out by obtaining on the video camera during rotation the rotor a plurality of frames of the video image, selecting for analysis from the plurality of frames of the video image at least one frame for analysis and carrying out an analysis of the frame to determine a position of the tip of the blade in the frame.

As shown in FIGS. 5 and 6, the frame selected is located at a predetermined angular position of the blade of the rotor which in this example is at the horizon on the downwind side or on the side angularly beyond the tower since this location can be readily determined in the images during analysis.

The method requires a camera on each blade and the method includes selecting and comparing the position of the tips in the frames at the same angular location and at the same power and wind conditions.

While only one analysis is shown in the above Figures it will be appreciated that the video image is taken during a period sufficient to contain different loading conditions on the blades. Thus the analysis can be repeated.

The method also includes, as shown in FIGS. 5 and 6, the step of selecting at least two frames at different loading conditions for comparison of the deflection of the blades at different loads.

The cameras 8D, 8F and 8K for example are provided on the same location on each of the three blades so that the position of the tips in the frames at the same loading conditions can be taken by those cameras and compared at the same angular orientation.

As shown in FIGS. 5 and 6, the image or frame is analyzed by detecting and defining in the frame the peripheral edge of the remote end of the blade as visible in the image. This edge can be traced manually by observing one image of one blade and looking on the image for the edge which is then traced directly in the image. The three images of the three separate blades can then be superimposed to properly locate the three edges relative to one another on the same image.

In some cases the comparison test described above the deflection differences were enough to confirm substantial mechanical deviations between blade manufactures or could confirm severe structural damage (delamination) after lightning strike. In the latter case it confirmed the need for further investigation or blade exchange.

Using the data collection system 20, the images are analyzed at different load, capacity, power produced or environmental data such as wind speed and similar. That is the recorded camera video streams are time synchronized analyzed potentially with external data providing load, capacity, power produced or environmental data such as wind speed and similar.

The position of the desired blade part (for instance tip position) can either be determined or measured in the videos or in isolated still frames. In the example below the horizon was chosen as reference point providing enough certainty that the blades experience the same wind.

As shown in FIGS. 6, 7 and 9 at around 6% load (close to load free and freewheeling) all three blades match very close in position. Already at 33% two blades significantly deflect more than the third blade.

In order to obtain actual values of deflections as opposed to the comparison test described above in some tests it is possible by knowing the geometric dimensions of the blade at or adjacent the deflection, the amount of the deflection in actual length (meter) can be calculated and verified against design values. That is typically the tip of the blade is formed of a separate material to that a line of separation of the tip relative to the remainder of the blade can be determined. As the width of the blade at this location is known from the design drawings, this value of width can be used in the image to compare to the amount of deflection measured in the image to obtain an actual numerical value for the amount of deflection. If the tip separation line is not available or is not suitable, other positions along the length of the blade can be used by analysis of the design construction of the blade and by creation of imaginary lines at spaced positions along the blade from those design constructions.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of detecting an amount of deflection of the blades of a rotor of a wind turbine,
the wind turbine comprising a tower and a nacelle mounted to the top of the tower, the rotor being rotatably connected to the nacelle for rotating about a rotor axis and having a plurality of equally spaced blades,
the method comprising:
positioning a video camera on the rotor at a root of a respective one of the blades so as to provide a line of sight of the camera along the respective one of the blades to the tip to obtain a video image of the rotor and tip;
and carrying out an analysis of the images of the tip to determine a position of the tip and hence the deflection of the tip.

2. The method according to claim 1 wherein the analysis is carried out by obtaining on the camera during rotation of the rotor a plurality of frames of the video image, selecting for analysis from the plurality of frames of the video image at least one frame for analysis and carrying out an analysis of the frame to determine a position of the tip of the blade in the frame.

3. The method according to claim 2 wherein the frame selected is located at a predetermined angular position of the blade of the rotor.

4. The method according to claim 3 wherein the predetermined angular position of the blade of the rotor is located at the horizon.

5. The method according to claim 1 wherein predetermined angular position of the blade of the rotor is located at the horizon on the side angularly beyond the tower.

6. The method according to claim 1 wherein there is provided a camera on each blade and the method includes selecting and comparing the position of the tips in the images.

7. The method according to claim 6 wherein the images selected for the blades are located at the same predetermined angular position of the blade of the rotor.

8. The method according to claim 1 wherein the video image is taken during a period sufficient to contain different loading conditions on the blades.

9. The method according to claim 8 wherein at least two images are selected at different loading conditions for comparison of deflection at different loads.

10. The method according to claim 1 wherein there is provided a camera on each blade and the method includes selecting and comparing the position of the tips in the images at the same loading conditions.

11. The method according to claim 1 wherein there is provided a camera on each blade and the method includes selecting and comparing the position of the tips in the images at the same angular orientation.

12. The method according to claim 1 wherein the image is analyzed by detecting and defining in the frame the peripheral edge of blade.

13. The method according to claim 1 wherein the geometric dimensions of the blade at positions along the blade are used for calculating the deflection in actual length and verified against design values.

14. The method according to claim 13 wherein known width dimension at a predetermined position along the blade is used to calculate an actual value of the deflection.

15. The method according to claim 1 wherein the images are analyzed at different load, capacity, power produced or environmental data such as wind speed and similar.

16. The method according to claim 1 wherein the cameras are mounted on the high pressure side or downwind side of the blade looking along the blade at the leading edge.

17. The method according to claim 1 wherein the cameras are mounted at the root of the blade for blades

18. The method according to claim 1 wherein the cameras are lined up along the blade's longitudinal axes

19. The method according to claim 1 wherein the camera video streams are time synchronized analyzed potentially with external data providing load, capacity, power produced or environmental data.
